(19) United States
(12) Patent Application Publication
(10) Pub. No.: US 2019/0247988 A1
(43) Pub. Date: Aug. 15, 2019

(54) Tool to remove damaged bolt heads

(71) Applicant: Jason Oelke, Corona, CA (US)

(72) Inventor: Jason Oelke, Corona, CA (US)

(21) Appl. No.: 15/894,583

(22) Filed: Feb. 12, 2018

(51) Int. Cl. B25B 27/00; B67B 7/18

(52) U.S. Cl. CPC B25B 27/0042; B67B 7/18

(57) ABSTRACT

A tool to remove square head drain plugs of the type found in diesel semi-truck rear differentials. The tool consists of two circular portions that are joined together. The first circular portion having a void to insert a square head drain plug and the second circular portion having a void to insert a ½ inch ratchet drive. The tool is used by first inserting the square head drain plug into the first circular portion and, if needed, a hammer may be used to force the tool onto the square head drain plug. Then a ratchet wrench is inserted into the void in the second circular portion so that the ratchet wrench may be utilized to rotate the tool. The tool is made from high strength metal so as to overcome resistance presented by rounded edges that may be exist on drain plugs.

### BACKGROUND OF THE INVENTION

### 1. Field of the Invention

The present invention relates generally to fastener extraction devices and, more particularly, to fastener impact devices for extracting a fastener containing rounded corners on its head from a workpiece by (i) positioning the device on top of the fastener's head, (ii) striking the device with a hammer to cut into the fastener's head in order to remove rounded corners, and (iii) simplifying the removal of the fastener increasing the rotational torquing force that may be applied to the fastener.

### 2. Description of the Related Art

Removing fasteners from a workpiece after the fastener's head has been rounded is difficult and a number of solutions have been proposed. Some solutions, such as U.S. Pat. No. 6,877,401 to Jon Giltner and U.S. Pat. No. 8,607,670 to Rafal Stawarski, discloses a tool to cut into the fastener with a reverse threading action so as to grip the fastener's head thus destroying the fastener's head in the process. Other solutions, such as U.S. Pat. No. 8,955,415 to Fu-Hua Lin, propose first to make a hole into the head of the fastener and then to insert a tool that will grip the fastener the further it is threaded into the hole and then remove the fastener.

Known systems employ a method that results in the destruction of the fastener and use methods that are time consuming. It would be beneficial to mechanics to have a tool that does not destroy the fastener in the process of removing the fastener and that would not be time consuming in its use.

### BRIEF SUMMARY OF THE INVENTION

The preferred embodiment of the tool of the present invention is a socket in the shape of the number “8” rather than being cylindrical in shape as most other sockets are. The void in the upper portion of the tool is sized so as to fit closely over square oil drain plugs commoningly found on diesel semi-trucks. The void in the lower portion of the tool is sized so as to fit onto standard ratchet wrenches. At times the oil drain plug head may have had its edges “rounded” when being inserted or removed by sockets that are not dimensioned to tightly fit of the head of the oil drain plug thus making subsequent insertions and removals of the oil drain plug more difficult. The tool itself may be made from any metal alloy that is harder than the metal alloy used to make oil drain plugs and the edges of the void in the upper portion of the tool are sharpened so as to restore the oil drain plug head back to its normal square shape if the oil drain plug head has rounded edges.

To use the tool one would first place the void found in the upper portion of the tool over the oil drain plug head so that the head may pass into the void. If the plug's head refuses to pass into the void because either the plug's head is slightly oversized or it's edges are rounded, a hammer may be used to force the tool upon the head of the plug by striking the tool when the tool is positioned over the plug's head. When the tool is being forced upon the plug's head, the sharpened edges of the void cut through any excess or deformed metal thus reshaping the head of the plug back to its original square shape. Once the plug's head has passed into the void found in the upper portion of the tool, the drive of a ratchet wrench or similar tool is then inserted into the void found in the lower portion of the tool. The user may apply a torquing force to the ratchet wrench which in turn applies torque to the tool for the insertion or removal of the oil drain plug.

A secondary embodiment of the tool of the present invention contains the upper void of the preferred embodiment containing the sharpened edges but replaces the lower void with a handle so that the use of a ratchet wrench or other similar tool will not be required.

Yet another embodiment of the tool of the present invention reconfigures the tool to be cylindrical in shape with a first opening matching the characteristics of the void in the upper portion of the preferred embodiment and a second opening matching the characteristics of the void in the lower portion of the preferred embodiment.

Yet another embodiment of the tool of the present invention maintains the same configuration of the number “8” as the preferred embodiment but replaces the square void in the upper portion with a void to accommodate oil drain plugs with a hexagonal head.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Neither this summary nor the following detailed description defines or limits the invention. The invention is defined by the claims.

### BRIEF DESCRIPTION OF DRAWINGS

The present invention will become more fully understood from the detailed description and accompanying drawings, wherein:

FIG. 1 is an isometric view of the preferred embodiment of the tool of the present invention.

FIG. 2 is an isometric view of the preferred embodiment of the tool showing its interaction with a ratchet wrench and oil drain plug.

FIG. 3 shows the preferred embodiment of the tool in use with a ratchet wrench to insert or remove a oil drain plug.

FIG. 4 is an isometric view of a alternate embodiment of the tool of the present invention.

FIG. 5 is an isometric view of a second alternate embodiment of the tool of the present invention.

FIG. 6 is an isometric view of a third alternate embodiment of the tool of the present invention.

### DETAILED DESCRIPTION OF THE INVENTION

The following description of the preferred embodiment(s) is merely exemplary in nature and is in no way intended to limit the invention, its application, or uses.

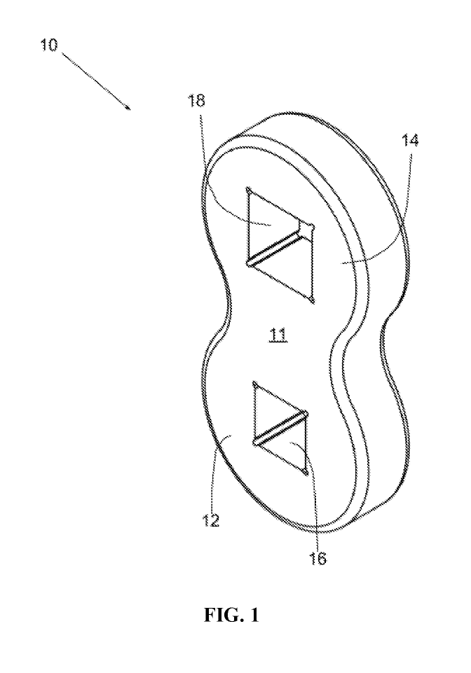

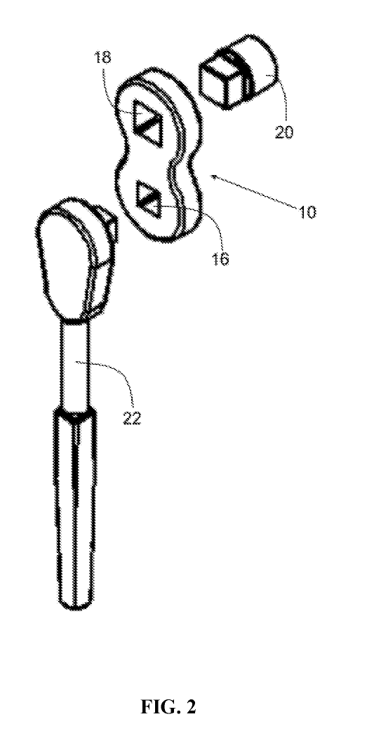

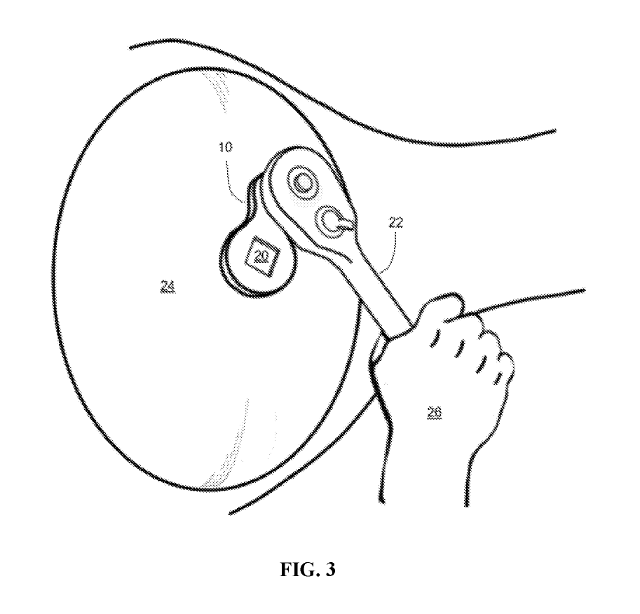

FIG. 1 shows an isometric view of the preferred embodiment of the tool 10 of the present invention. Tool 10 is approximately rectangular in shape with an indentation at its mid section to facilitate grasping such that versions of tool 10 that are shorter in length appear as the number “8”. Tool 10 may be of any reasonable length and indeed the greater the length that greater amount of torque may be applied when engaging the oil drain plug (“plug”). One half of the tool, drive portion 12, contains drive socket 16 and is used to engage with ratchet wrench 22 as shown in FIGS. 2 and 3. The opposing half, head portion 14, contains head socket 18 and is used to engage with plug 20 as shown in FIGS. 2 and 3. Frame 11 of tool 10 is to be fabricated of a metal that is much harder than metals used for fabrication of the plugs and must not break apart when being force upon the plugs by a hammer. The opening of drive socket 18 is dimensioned to be only slightly larger than the dimensions of the plug's head of the plug that is to be removed and the edges of drive socket 18 are sharpened so as to facilitate the removal of any material present on the surface of the plug's head. The material referred to here may be excess material present as a result of a manufacturing process or from rounding the edges of the plug's head during failed attempts at removing the plug.

Tool 10 may be used to insert plugs but its primary purpose is to remove plugs whose heads have been rounded due to previous failed attempts at removing the plug. The sharpened edges of head socket 18 cut away excess material from the plug's head that prevents other tools from securely gripping the head. To use tool 10 a user will first position head socket 18 over a plug's head and attempt to fit head socket 18 onto the plug's head. As the dimensions of head socket 18 are only slightly larger than the dimensions of the plug's head, any excess material present on the plug's head will prevent head socket 18 from fitting about the plug's head. By striking tool 10 with a hammer, excess material present on the plug's head will be removed by the sharpened edges of head socket 18 allowing tool 10 to be fitted about the plug's head. Once head socket 18 is about the plug's head a ratchet wrench may then engage drive socket 16 and the user may turn the plug by operation of the ratchet wrench.

FIG. 2 shows tool 10 in relationship to ratchet wrench 22 and plug 20. Head socket 18 of tool 10 engages the head of plug 20. Drive socket 16 of tool 10 engages ratchet wrench 22. The distance between head socket 18 and drive socket 16 adds to the torquing force present in ratchet wrench 22. The longer the distance between head socket 18 and drive socket 16 the greater the torquing force.

FIG. 3 shows tool 10 in use to remove plug 20 from rear differential 24. In FIG. 3 tool 10 head socket 18 has been fitted about the head of plug 20 and ratchet wrench 22 has engaged tool 10 drive socket 16 which is not visible. User 26 operates on ratchet wrench 22 which in turn operates on tool 10 which in turn operates to remove plug 20.

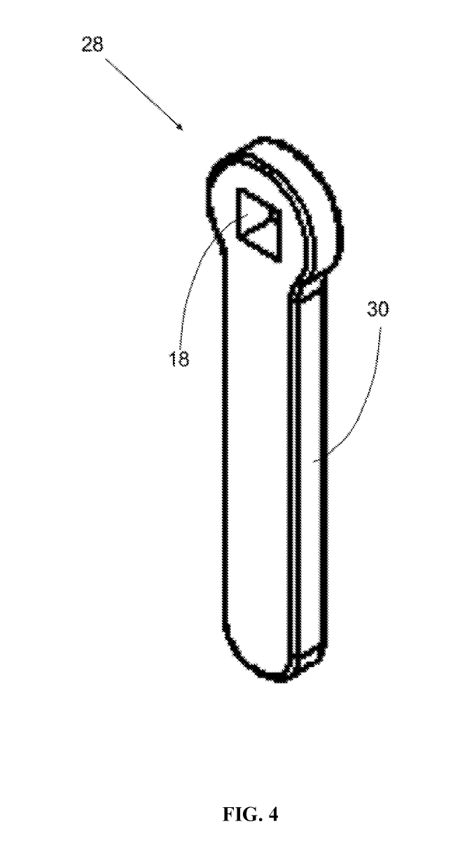

FIG. 4 shows secondary embodiment of the present invention, tool 28. Tool 28 differs from the preferred embodiment, tool 10, in that drive portion 12 is replaced by handle 30. Head portion 14 containing head socket 18 remains the same as in tool 10. The method of use for tool 28 is the same as for tool 10 except that ratchet wrench is not used and user 26 operates on tool 28 directly by use of handle 30.

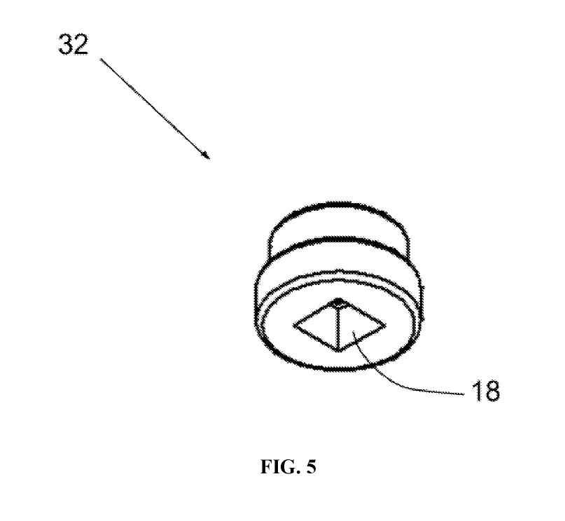

FIG. 5 shows another secondary embodiment of the present invention, tool 32. Tool 32 differs from the preferred embodiment, tool 10, in that tool 32 is cylindrical as contrasted with tool 10 which is more rectangular. At one end of tool 32 is head socket 18 while at the opposing end is drive socket 16 which is not visible. Tool 32 is used in a manner similar to tool 10. Tool 32 is first positioned over the plug's head and if needed is struck by a hammer so that tool 32 is fitted about the plug's head. Then the user engages ratchet wrench into tool 32 and operates the ratchet wrench to apply a torquing force on tool 32 to remove the plug. As both drive socket 16 and head socket 18 are along the same axis, tool 32 does not add to the torquing effect when engaged with ratchet wrench 22.

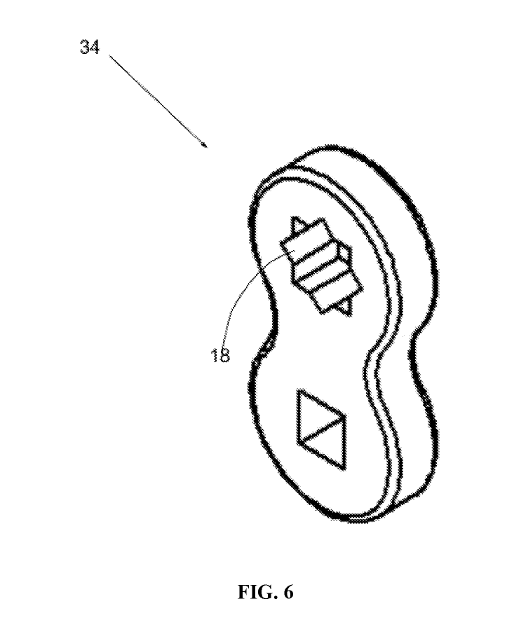

FIG. 6 shows another secondary embodiment of the present invention, tool 34. Tool 34 differs from the preferred embodiment, tool 10, in that tool 34 has head socket 18 that has been configured for use on plugs that have heads that are hexagonal in shape rather than square.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A tool to remove a drain plug said tool comprising:
a rectangular slab of material of a thickness greater than the head of said drain plug and a length greater than its width describing a longitudinal axis;
a first void at first end of said longitudinal axis to receive the driver of a ratchet wrench to engage said tool; and
a second void at second end of said longitudinal axis dimensioned to be slightly larger than the head of said drain plug and to receive the head of said drain plug.

2. The tool of claim 1 wherein said second void having sharpened edges to facilitate the removal of any excess material present on said drain plug head when said tool is forced on said drain plug head.

3. The tool of claim 1 wherein said second void is shaped to receive said drain plugs with a square or hexagonal head.

4. A tool to remove a drain plug said tool comprising:
a rectangular slab of material of a thickness greater than the head of said drain plug and a length greater than its width describing a longitudinal axis; and
a first void at first end of said longitudinal axis dimensioned to be slightly larger than the head of said drain plug and to receive the head of said drain plug.

5. The tool of claim 4 wherein said first void having sharpened edges to facilitate the removal of any excess material present on said drain plug head when said tool is forced on said drain plug head.

6. The tool of claim 4 wherein said first void is shaped to receive said drain plugs with a square or hexagonal head.

7. A tool to remove a drain plug said tool comprising:
a cylindrical body of material with a first and second opening along its longitudinal axis;
said first opening dimensioned to be slightly larger than the head of said drain plug; and
said second opening dimensioned to receive the driver of a ratchet wrench.

8. The tool of claim 7 wherein said first opening having sharpened edges to facilitate the removal of any excess material present on said drain plug head when said tool is forced on said drain plug head.
